(19) United States
(12) Patent Application Publication
(10) Pub. No.: US 2023/0048393 A1
(43) Pub. Date: Feb. 16, 2023

(54) Thumbnail Image Replacement

(71) Applicant: DISH Network L.L.C., Englewood, CO (US)

(72) Inventors: Ashok Soni, Aurora, CO (US); Joseph Natale, Aurora, CO (US)

(73) Assignee: DISH Network L.L.C., Englewood, CO (US)

(21) Appl. No.: 17/884,372

(22) Filed: Aug. 9, 2022

Related U.S. Application Data
(60) Provisional application No. 63/232,117, filed on Aug. 11, 2021.

(51) Int. Cl. H04N 21/266; G06V 10/764

(52) U.S. Cl. CPC H04N 21/266; G06V 10/764

(57) ABSTRACT

Methods for recognizing thumbnails may include operations of receiving an identification of a thumbnail source for content, receiving the thumbnail, computing a hash value for the thumbnail, and associating the hash value with the thumbnail. Operations for content characterization may include launching an image analysis application, selecting a top level category to apply to a thumbnail, providing the thumbnail to the image analysis application, applying the selected top level category to the thumbnail to determine if the thumbnail satisfies the top level category, if satisfied, associating the top level category with the thumbnail, and repeating the one or more of the above operations with respect to a second category. Operations may include receiving an identification of a node to receive a thumbnail, obtaining a node selected category, receiving a proposed thumbnail to provide to the node, and determining if the proposed thumbnail has been previously recognized and categorized.

### CROSS-REFERENCE TO RELATED APPLICATIONS

This application claims priority to U.S. Provisional Application Ser. No. 63/232,117, which was filed on 11 Aug. 2021, in the name of inventors Ashok Soni, Hawk Allen McGinty, and Joseph Natale, and is entitled “Thumbnail Image Replacement”—the entire contents of which are incorporated herein by reference.

### TECHNICAL FIELD

The technology described herein generally relates to devices, systems, and processes for facilitating replacement of thumbnail images.

### BACKGROUND

Today, content distributors such as satellite and cable companies, over-the-top content providers, streaming service providers and others commonly utilize thumbnail images to identify content available for selection to a user. Thumbnails may include still and/or motion video images. Thumbnails may include audio portions along with video portions. Commonly, the thumbnail is provided by a provider of the underlying content. Thumbnails may also be provided by a guide service provider, or others.

Typically, a thumbnail corresponds to the underlying content. For example, a video of a Western may include a thumbnail depicting a cowboy, or other character, on a horse. Similarly, a thumbnail for a science fiction movie depicting spaceships may include an image of a spaceship presented in the movie. Typically, thumbnails for such content are not objectionable to mature audiences, and may be objectionable to unmature audiences, such as children. Notably, thumbnails for adult content, such as pornographic content, often include images that are inappropriate for such unmature audiences. Today, the vast quantity of content available, across any let alone all of the ever expanding mediums, often makes the identification, filtering and non-providing of inappropriate thumbnails difficult if not impossible.

Often content distributors rely on thumbnail aggregators to filter the thumbnails they provide for inappropriate content and to remove those having such inappropriate content. Such filtering, if done at all, is commonly done today manually or with limited, if any automated processes.

Likewise, thumbnails and the like for other forms of content, such as those provided based upon web searches or the like are also commonly unfiltered and may result in the exposure of inappropriate content to unmature audiences. Accordingly, computer-implemented methods and systems are needed for identifying thumbnails, categorizing such thumbnails, identifying users content categories deemed acceptable and unacceptable, determining when a given thumbnail does not satisfy a given user's acceptable content categories and replacing such unacceptable thumbnail(s) with replacement thumbnails.

The various embodiments of the present disclosure address these and other needs.

### SUMMARY

Various implementations are described of devices, systems, and processes for facilitating thumbnail image replacement.

For at least one implementation, a computer-implemented method for recognizing thumbnails includes: receiving an identification of a source for a thumbnail for a given content; receiving the thumbnail from the source; computing a hash value for the thumbnail; and associating, in a database, the hash value with the thumbnail.

For at least one implementation, a computer-implemented method for content characterization includes: launching an image analysis application; selecting a top level category to apply to the thumbnail; providing the thumbnail to the image analysis application; applying the selected top level category to the thumbnail to determine if the thumbnail satisfies the top level category; if satisfied, associating the top level category with the thumbnail; and repeating the above operations to determine whether the thumbnail satisfies a second category.

For at least one implementation, a computer-implemented method for producing thumbnails for presentation to a user of a node may include: receiving an identification of a node to receive a thumbnail; obtaining a node selected category for the node; receiving a proposed thumbnail to provide to the node; determining if the proposed thumbnail has been previously recognized and categorized; if not, performing thumbnail recognition operations and categorization operations to generate any thumbnail categorizations; determining whether a match occurs between the node selected category and any thumbnail categorizations; if a match does not occur, communicating the proposed thumbnail to the node; if a match does occur, flagging the proposed thumbnail as not suitable for the node; identifying a replacement thumbnail; and communicating the replacement thumbnail to the node.

A system of one or more computers may be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method which may include receiving an identification of a source for a thumbnail for a given content; receiving the thumbnail, at a server, from the source; computing, at the server, a hash value for the thumbnail; associating, in a database accessible to the server, the hash value with the thumbnail; receiving an identification of a user of a given node; and where the given node is coupled to the server.

The method may also include determining by the server whether to output the thumbnail to the given node for presentation to the given user. Other embodiments of this aspect may include corresponding computer systems, apparatus, and computer programs recorded on one or more computer storage devices, each configured to perform the actions of the methods.

Implementations may include one or more of the following features. The computer-implement method where the source is a provider of augmented reality content. The thumbnail is received, from the source, as a non-humanly visually perceptible formatted thumbnail (herein, an nHPV thumbnail.

The method further may include: converting the thumbnail from the nHPV format into a humanly visually perceptible thumbnail (herein, an HPV thumbnail).

The method may include: performing image analysis on the HPV thumbnail; and based on a result of the image analysis; identifying a top-level category; and determining whether the HPV thumbnail corresponds with the top-level category. When corresponding, the method may include applying a category label, associated with the top-level category, to the HPV thumbnail; and based on the top-level category, determining whether to output the thumbnail to the given node for presentation by the given node to the given user. The top-level category may correspond to an explicit nudity category.

The computer-implemented method may include: based on a result of the image analysis, identifying a second-level category; further categorizing the HPV thumbnail as corresponding with the second-level category; and based on the second-level category, second determining whether to output the thumbnail to the given node for presentation by the give node to the given user.

The computer-implement method may include: filtering the thumbnail based on at least one of a time of day, a type of device, and location filter for the given node. The hash value may facilitate filtering of the thumbnail.

The computer-implemented method may include: at the given node, receiving the HPV thumbnail with the category label; determining whether the category label corresponds to a node selected category; and when corresponding, preventing presentation of the HPV thumbnail.

The computer-implemented method may include: when presentation of the HPV thumbnail is prevented, at the given node, requesting a replacement thumbnail for presentation in lieu of the HPV thumbnail; and at the server, identifying a replacement thumbnail and communicating the replacement thumbnail to the given node. The replacement thumbnail may be a generic thumbnail associated with at least one of a genre, actor, channel, producer, director and theme for the given content. The nHPV thumbnail may include a sound; and the HPV thumbnail may include a graphical image. The given content may include one of a television program, a movie, a streaming video, and graphical images associated with a computer game. Implementations of the described techniques may include hardware, a method or process, or computer software on a computer-accessible medium.

One general aspect includes a non-transitory machine-readable storage medium having stored thereon computer instructions which launch an image analysis application; select a top-level category to apply to a thumbnail; provide the thumbnail to the image analysis application; apply the selected top level category to the thumbnail to determine if the thumbnail satisfies the top-level category; and if satisfied, associate the top level category with the thumbnail and output the thumbnail for presentation at a given node when content in the top-level category is acceptable for presentation at the given node. Other embodiments of this aspect include corresponding computer systems, apparatus, and computer programs recorded on one or more computer storage devices, each configured to perform the actions of the methods.

Implementations may include one or more of the following features. The non-transitory machine-readable storage medium may include computer instructions which further cause the processor to perform operations that may include: repeating at least one of the launching, selecting, providing, applying, associating and outputting operations with respect to a second-level category.

The top-level category may categorize thumbnails as including nudity and the second-level category may be a subset of the top-level category and further categorize thumbnails as including explicit nudity.

The computer instructions may further cause the processor to perform operations that may include: filtering the thumbnail for presentation at the given node based upon at least one of a time of day at the given node and a location of the given node. Implementations of the described techniques may include hardware, a method or process, or computer software on a computer-accessible medium.

One general aspect includes an electronic device that includes a data storage and a processor coupled to the data storage. The processor executes non-transient computer instructions which cause the processor to perform operations including: receive an identification of a node to receive a proposed thumbnail; obtain a node selected category for the node; receive the proposed thumbnail to provide to the node; determine if the proposed thumbnail has been previously recognized and categorized; if not previously recognized and categorized, perform thumbnail recognition operations and categorization operations to generate a thumbnail categorization for the proposed thumbnail.

The electronic device may also determine whether a match occurs between the node selected category and the thumbnail categorizations and if a match does not occur, communicate the proposed thumbnail to the node. If a match does occur, the electronic device may flag the proposed thumbnail as not suitable for the node, identify a replacement thumbnail, and communicate the replacement thumbnail to the node. Other embodiments of this aspect include corresponding computer systems, apparatus, and computer programs recorded on one or more computer storage devices, each configured to perform the actions of the methods.

Implementations may include one or more of the following features. The electronic device may execute non-transient computer instructions which further cause the processor to perform operations including: obtain a filter setting associated with a node; determine whether the node, at a given current time, satisfies the filter setting; and if satisfied not communicate a thumbnail to the node. The filter setting may identify, for the node, at least one of a device type, a time of day, and a location when thumbnails are not to be provided to the node. Implementations of the described techniques may include hardware, a method or process, or computer software on a computer-accessible medium.

### BRIEF DESCRIPTION OF THE DRAWINGS

The features, aspects, advantages, functions, modules, and components of the devices, systems and processes provided by the various implementations of embodiments of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1 is a schematic illustration of a system for facilitating thumbnail image replacement and in accordance with at least one implementation of the present disclosure.

FIG. 2 illustrates a server configured for use in facilitating thumbnail image replacement and in accordance with at least one implementation of the present disclosure.

FIG. 3 illustrates a method for use by a thumbnail recognition engine in facilitating thumbnail image replacement and in accordance with at least one implementation of the present disclosure.

FIG. 4 illustrate a method for use in a thumbnail categorization engine in facilitating thumbnail image replacement and in accordance with at least one implementation of the present disclosure.

FIG. 5 illustrates a method for use in a thumbnail production engine in facilitating thumbnail image replacement and in accordance with at least one implementation of the present disclosure.

FIG. 6 illustrates a node configured for use in facilitating thumbnail image replacement and in accordance with at least one implementation of the present disclosure.

### DETAILED DESCRIPTION

Various implementations of the present disclosure describe devices, systems, and processes for facilitating thumbnail image replacement. As used herein, “thumbnail image replacement” refers to a process that includes one or more operations of: receiving a first image, identifying the first image, analyzing the first image to identify one or more elements of the first image, selecting an image filter, determining whether the first image passes a filter condition for the selected image filter, if the first image does not pass the filter condition, identifying a second image, and publishing one of the first image and the second image based upon the results of the determining operation.

As used herein, a reference to “Cloud” includes references to cloud computing, cloud storage, cloud communications, and/or other technology resources which a user may not actively manage the providing or use of such resources. A use of a Cloud resource may be private (limited to certain users and/or uses), public (available for many users and/or uses), hybrid, dedicated, non-dedicated, or otherwise. It is to be appreciated that any device or system of the various embodiments of the present disclosure may use Cloud resources to provide one or more Solutions.

“Substantially simultaneous” means without incurring a perceptible delay between a first event or condition, such as a sending of a request that results in a first image being received from a source thereof, and a second event or condition, such as the publishing of either the first image or the second/replacement image based upon a determination of whether the first image passes one or more filter conditions. It is to be appreciated that substantial simultaneity will vary based upon characteristics of the receiving nodes, analyzing nodes, and publishing nodes. For example, an action is substantially simultaneous with respect to node associated with a human user when an imperceptible human delay occurs. By another example, an action is substantial simultaneous with respect to a node associated with an automated or machine process, such as a computing process, when an action is performed without a delay greater than as needed to meet a given SLR.

“Separate” means a first node may be physically or virtually separated from one or more second nodes. Such separation may occur geographically, wherein a first node is in a different room, building, city, state, or country than one or more second nodes. The separation may occur virtually by use of distinct logical networks, distinct physical networks, or otherwise.

“Thumbnail” refers to any data that may be presented, using a suitable presentation device and after performing one or more data processing operations by one or more data processing devices, to a user in a humanly visually perceptible (HVP) format. Non-limiting examples of a thumbnail, include still and motion video images captured from and/or provided with television programs, movies, videos, computer gaming images, or otherwise. A thumbnail may originate from any source, including live, augmented reality, virtual reality, computer generated, or otherwise. A thumbnail may be presented to a given user, at a node (as described below). A thumbnail may be presented to one or more users real-time or otherwise. Thumbnails may be stored, transmitted, processed or otherwise manipulated in non-HVP formats that may be converted, by known and later arising devices, systems and methods, into HVP information presented by a suitable presentation device. Current embodiments of such presentation devices are well known any suitable known or later arising presentation device may be used for thumbnail presentation to users non-limiting examples including televisions, video displays, smartphone displays, automobile infotainment system displays, tablet computers, virtual and/or augmented reality displays, smart glasses, and otherwise.

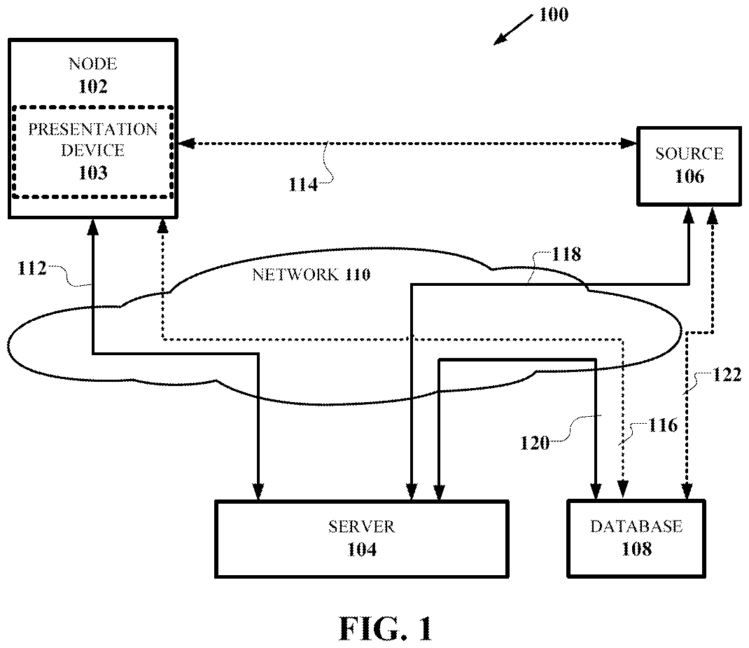

As shown in FIG. 1, one implementation of a system 100 for facilitating thumbnail image replacement includes a node 102 coupled, via a network 110 and/or one or more communication links, to a server 104. The server 104 may be configured to filter thumbnails received from a source 106. A database 108 may be configured to store thumbnails and/or one or more characterizations of content. One or more of the nodes 102, server, 104, source 106, and a database 108 may be communicatively coupled by the network 110.

As used herein, a “node” 102 is any electronic device configurable to present received thumbnails. The thumbnails may be received directly or indirectly, from another node, the server 104, the database 108 or other data storage device, the source 106, or otherwise. A node 102 may be a stand-alone device, such as a human user's laptop computer, personal computer, smartphone, gaming device, or the like. A node 102 may be a thread operating on a computing system having a multiple threaded operating system, such as the WINDOWS 10 operating system, LINUX, APPLE OS, ANDROID, and others. A node 102 may be an application program executing on a computing device, a web service, or otherwise. An Application Program Interface (API) may be used by a node 102 to support an implementation of the present application. A node 102 may occur in the virtual domain and/or in the physical domain. A node 102 may be associated with a human user, a machine process executing on one or more computing devices, an API, a web service, instantiated on the Cloud, distributed across multiple computing devices, or otherwise.

A node 102 may include or be communicatively coupled to a presentation device 103 configured to present thumbnails as HVP information. Non-limiting examples of presentation devices include video displays, such as Light Emitting Diode (LED) displays, Liquid Crystal Displays (LCDs), Organic LED (OLED) displays, plasma displays, cathode ray tube displays, and otherwise. Any known or later arising device or combinations thereof configured to present thumbnail data to a user in a HVP information format.

As shown in FIG. 1, the system 100 includes a node 102 communicatively coupled by a first link 112 (also referred to as the node-server link) with the server 104, by a second link 114 (also referred to as the node-source link) with the source 106, and by a third link 116 (also referred to as the node-database link) with the database 108. For other implementations, any number of nodes and/or links may be used. Further, it is to be appreciated that the links may be bi-directional, uni-directional, or otherwise.

The system 100 includes a server 104. The server 104 may be communicatively coupled, by a fourth link 118 (also referred to as the server-source link) to the source 106 and by a fifth link 120 (also referred to as the server-database link) to the database 108. The database 108 may be communicatively coupled by a sixth link 122 (also referred to as the database-source link) to the source 106. The node links 112-122 may be transient links, existing to communicate thumbnails and/or characterizations thereof between the various system elements. The links 112-122 may utilize any form of communications architecture, protocols, topologies, technologies, or otherwise. The links 112-122 may utilize the Cloud, be direct links, use one or more networks such as network 110, or otherwise.

The network 110 includes physical data processing and communication components. Non-limiting examples of network components include data processing and communications components including computer servers, blade servers, switches, routers, encryption/decryption and other data security components, data storage and warehousing components, communication links such as those provided by wired connections, wireless connections including micro-wave, 3G/4G/5G, WIFI, and other types, satellite connections, fiber optic connections, and other components. Any known or later arising physical data processing and/or communications components may be utilized including actual physical and/or virtualized components.

As is well known, network 110 physical data processing and communications components may be logically defined, organized and utilized by a network function virtualization infrastructure (not shown). The virtualization of data processing and communications component infrastructures is well known in the art and any known or later arising topologies, approaches, methods, protocols, or the like for such virtualization may be utilized.

### Server 104

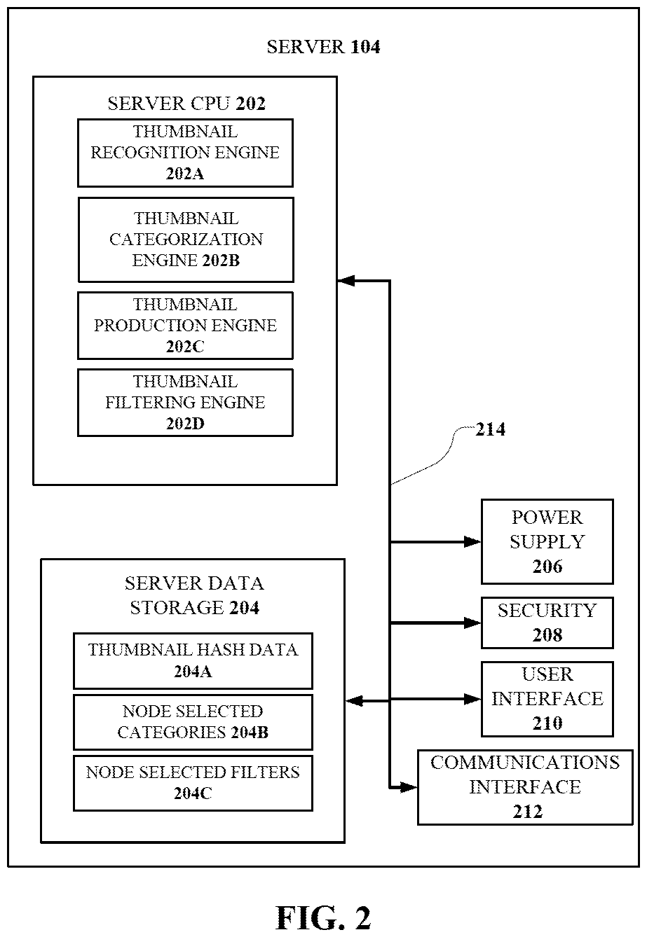

As shown in FIGS. 1 and 2, the server 104 is an electronic device and may include and/or be communicatively coupled to a server central processing unit (CPU) 202. The server CPU 202 may be provided by any processing device capable of executing one more computer executable instructions (herein, a “computer instruction”) which, in accordance with an implementation of the present disclosure, facilitates one or more data processing operations including, and not limited to, one or more computer engines such as a thumbnail recognition engine 202A, a thumbnail categorization engine 202B, a thumbnail production engine 202C, and a thumbnail filtering engine 202D, (such computer engines are further described below). One or more of the computer engines 202-A/D may be combined, included, not included, distributed across one or more devices, such as being provided in whole or in part by a node 102, a network component 110, or otherwise.

The server CPU 202 may include one or more physical and/or logical components configured for such data processing operations. The server CPU 202 may include one or more hardware processors, such as 32-bit and 64-bit central processing units, multi-core ARM based processors, microprocessors, microcontrollers, and otherwise. The processors may be physically and/or virtually instantiated. The processors provided by the server CPU 202 may be localized, distributed, Cloud based, or otherwise provided. The computer instructions may include instructions for executing one or more application programs, application program interfaces (APIs), software computer engines, and/or other processes configured to perform computer executable operations are herein identified as being “engines.” Such engines may arise in any computing configuration including, and not limited to, local, remote, distributed, blade, virtual, or other configurations and/or systems configured for use in support of an implementation of one or more embodiments of the present disclosure.

### Thumbnail Recognition Engine (TRE) 202A

The server 104 may execute computer instructions instantiating a Thumbnail Recognition Engine (“TRE”) 202A. For at least one implementation, the TRE 202A facilitates recognition of thumbnails by performing one or more operations, such as those shown in FIG. 3. The TRE 202A may be configured to recognize a thumbnail by, receiving an identification of the source 106 from which a given thumbnail for a given content may be retrieved (Operation 302). The operations may include receiving the thumbnail as a graphical image from the source (Operation 304). For at least one implementation, the graphical image corresponds to a given content, such as a movie, video production, television show, or otherwise. The thumbnail may include a representative graphical image identifying one or more of an actor, a theme, a concept, a title, a location, a director, a subject matter, an inference, or otherwise for the given content. The operations may include computing a hash value for the thumbnail (Operation 306). The hash value may be computed, for an implementation, as an MD5 hash value. As known in the art, an MD5 hash value may be computed by taking a string of data, of any length, and encoding such string of data into a 128-bit fingerprint. Other forms of thumbnail and/or graphical image recognition may be used for other implementations including, but not limited, to metadata analysis, bookmarks, and otherwise. The operations may include storing and/or associating, in the server data storage 204, such as a in thumbnail hash data 204A or in another data structure, and/or in the database 108, the computed hash value for the thumbnail (Operation 308). For at least one implementation, the thumbnail may also be stored with the hash value.

### Thumbnail Categorization Engine (TCE) 202B

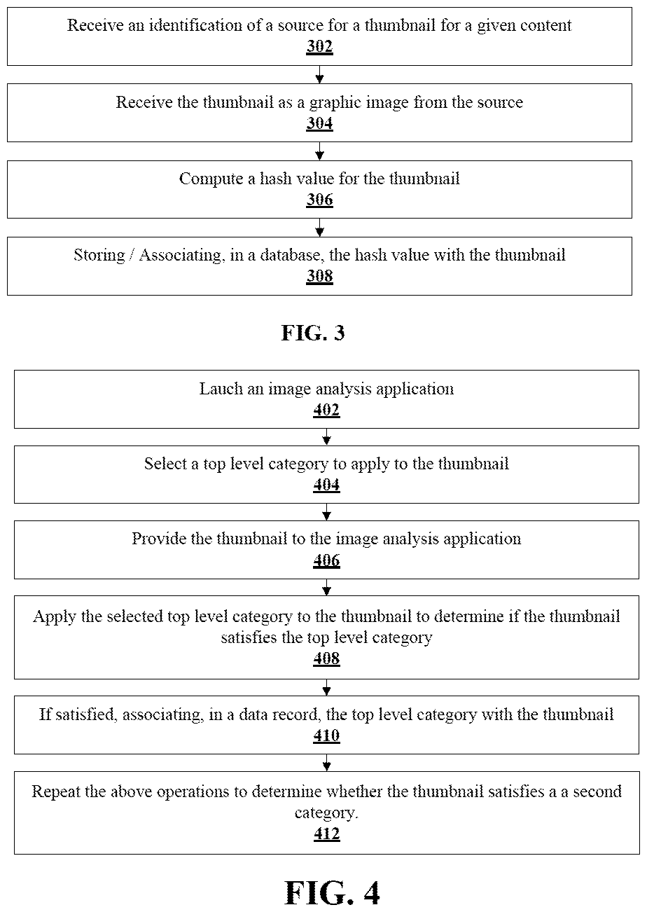

The server 104 may execute computer instructions instantiating a Thumbnail Categorization Engine (“TCE”) 202B. For at least one implementation, the TCE 202B facilitates characterizations of thumbnails by performing one or more operations, such as those shown in FIG. 4. The TCE 202B may be configured to categorize a given thumbnail by, launching an image analysis application (Operation 402). A non-limiting example of an image analysis application is the REKOGNITION™ application provided by Amazon Web Services (AWS). The operations may include selecting a top level category to apply to the thumbnail (Operation 404). For example, a top level category related to inappropriate graphical images may include top level categories of explicit nudity, suggestive nudity, and others. The operations may include providing the thumbnail to the image analysis application (Operation 406). The operations may include applying the selected top level category to the thumbnail to determine whether the thumbnail satisfies the top level category (Operation 408). If satisfied, the operations may include associating, in a data record, the top level category with the thumbnail (Operation 410). Such associating may include use of a category label. The operations may include repeating operations 404 to 408 to determine whether the thumbnail satisfies a second category such as another top level category and/or a second-level category (Operation 412). For example, a second-level category may include use of a category with more specificity. For example, a second level category of “male genitalia” may be provide greater specific to a top level category of “nudity.” Any categories and at any level of specificity may be used for an implementation of the present disclosure.

For at least one implementation, the TCE may be configured to apply the operations depicted in FIG. 4 and described above to a thumbnail received from a source 106. For another implementation, the TCE may be configured to determine whether a hash value for a received thumbnail corresponds to a previously determined hash value for a previously received thumbnail, as determined for example per the operations of FIG. 3 (or otherwise). If a correspondence exists, the TCE may be configured to determine whether the previously recognized thumbnail (as recognized by its associated hash value in thumbnail hash data 204A) has been previously categorized and, if so, utilize any such one or more categorizations with any subsequent decisions performed by the thumbnail production engine 202C, as described below.

### Thumbnail Production Engine (TPE) 202C

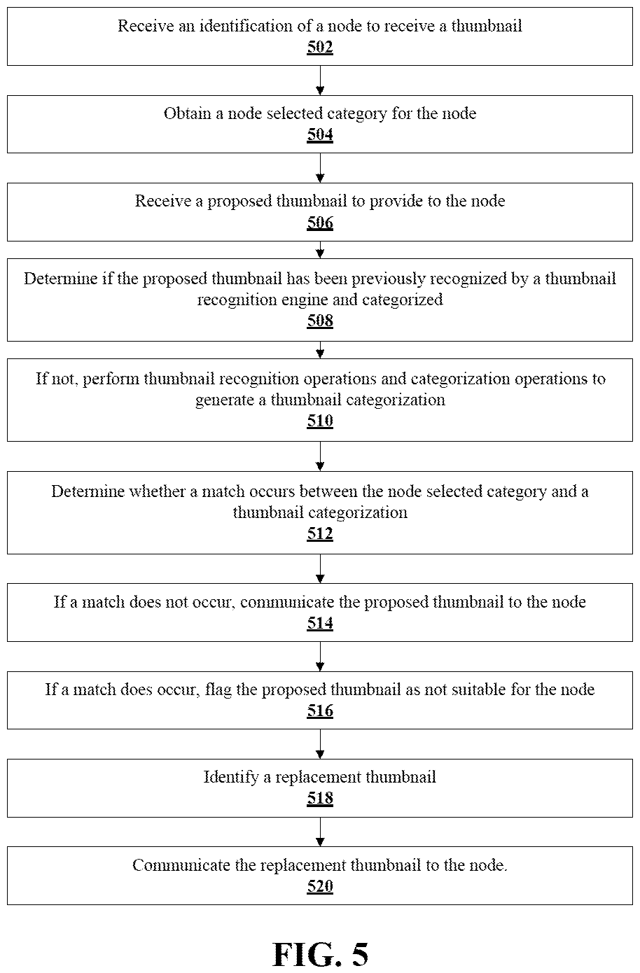

The server 104 may execute computer instructions instantiating a Thumbnail Production Engine (“TPE”) 202C. For at least one implementation, the TPE 202C facilitates the production of thumbnails to a node 102 by performing one or more operations, such as those shown in FIG. 5. For at least one implementation, the TPE 202C may be configured to utilize, with respect to a given node 102 or collection of nodes, one or more selected categories as provided in a node selected categories data 204B. The categories identified in a given node selected categories data 204B may be populated in any given manner. For example, the one or more categories may be identified by a given node 102 and communicated to the server 104. Likewise, the categories may be default categories, specified by law, commercial industry, societal norms, and/or otherwise. For example, a first node may be associated with children in a given household and a node selected categories data 204B for such first node may specify that thumbnails satisfying a top level category are not to be presented at the first node. Contrarily, a second node may be associated with an adult household where thumbnails satisfying the top level category may be presented. Thumbnails satisfying a lower level category are not to be presented at the second node.

As shown in FIG. 5, operations performed by the TPE 202C may include receiving an identification of a node to receive a thumbnail (Operation 502). The operations may include obtaining a node selected category file for the node (Operation 504). The operations may include receiving a proposed thumbnail to provide to the node (Operation 506). The operations may include determining if the proposed thumbnail has been previously recognized by a thumbnail recognition engine (for example, as per one or more of the operations of FIG. 3) and categorized (for example, as per one or more of the operations of FIG. 4) (Operation 508). If not, then thumbnail recognition and/or categorization operations are performed on the proposed thumbnail to generate a thumbnail categorization, if any (Operation 510). The operations may include determining, based upon the node selected category and any categorizes associated with the proposed thumbnail, whether a match occurs (Operation 512). If a match does not occur, the operations may include communicating the proposed thumbnail to the node (Operation 514). If a match does occur, the operations may include flagging the proposed thumbnail as not suitable for the node (Operation 516), identifying a replacement thumbnail (Operation 518), and communicating the replacement thumbnail to the node (Operation 520).

### Thumbnail Filtering Engine (TFE) 202D

The server 104 may execute computer instructions instantiating a Thumbnail Filtering Engine (“TFE”) 202D. For at least one implementation, the TFE 202D facilitates the filtering of produced thumbnails for use by a node 102 by performing one or more operation. For at least one implementation, the TFE 202D may be configured to utilize, with respect to a given node 102 or collection of nodes, one or more selected filters as provided in a node selected filters data file 204C. The filters identified in a given node selected filters data file 204C may be populated in any given manner. For example, the one or more filters may be identified by a given node 102 and communicated to the server 104. Likewise, the filters may be default filters, specified by law, commercial industry, societal norms, and/or otherwise. For example, a first node may be associated with children in a given household and a node selected filters 204C for such first node may specify that thumbnails satisfying a top level filter are not to be presented at the first node. Contrarily, a second node may be associated with an adult household where thumbnails satisfying the top level filter may be presented. Thumbnails satisfying a lower level filter are not to be presented at the second node. Filters may be based on content categories, presentation, display device types, times of day at a node, days of week, location of a node, characteristics of one or more users associated with a node, and otherwise. For a non-limiting example, a node associated with a children's playroom may be associated with different time of day filters, device type, and other filters, while a node associated with a primary or parent's bedroom may not be associated with any filters.

For at least one implementation, the identifying of a replacement thumbnail may include identifying a generic thumbnail for use. The generic thumbnail may include, for at least one implementation, a message indicating that inappropriate, objectionable, or other content has been removed. For an implementation, a thumbnail associated with a genre, actor, channel, producer, director, theme, or otherwise may be identified as a replacement thumbnail.

### Server Data Storage 204

The server CPU 202 may be communicatively coupled by a server data bus 214, or similar structure, to a server data storage 204, which may also be referred to as a “computer readable storage medium.” The server data storage 204 may be a single storage device, multiple storage devices, or otherwise. The server data storage 204 may be provided locally with the server 104 or remotely, such as a data storage service provided on the Cloud, by the database 108, and/or otherwise. Storage of data including, and not limited to, thumbnail hash data 204A, node selected categories data 204B, and other data may be managed by a storage controller (not shown) or similar component.

It is to be appreciated that a storage controller manages the storing of data and may be instantiated in one or more of the server data storage 204, the server CPU 202, on the Cloud, on the database 108, or otherwise. Any known or later arising storage technologies may be utilized. Non-limiting examples of devices that may be configured for use as server data storage 204 include electrical storage devices, such as EEPROMs, random access memory (RAM), Flash drives, and solid-state drives, optical drives such as DVDs and CDs, magnetic storage devices, such as hard drive discs, magnetic drives, magnetic tapes, memory cards, such as Compact Flash (CF), Secure Digital (SD) cards, Universal Serial Bus (USB) cards, and others.

Available storage provided by the server data storage 204 may be partitioned or otherwise designated by the storage controller, or otherwise, as providing for permanent storage and temporary storage. Non-transient data, transient data, computer instructions, or the like may be suitably stored in the server data storage 204 for any amount of time used to execute one or more computer instructions. While being used for execution of a computer instruction, such data is herein considered to be non-transient. While stored by the storage device, data is herein considered to be non-transient. As used herein, permanent storage is distinguished from temporary storage, with the latter providing a location for temporarily storing data, variables, or other instructions used for a then arising data processing operations. A non-limiting example of a temporary storage device is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient computer instructions and other data.

The server 104 may be any computing device capable of facilitating one or more of the operations described herein and/or otherwise provided by an implementation of the present disclosure.

### Server Power Supply 206

The server 104 may be configured to include a server power supply 206. The server power supply 206 may include any known or later arising technologies which facilitate the storage, supplying, transforming, or other use of electrical energy. Non-limiting examples of such technologies include batteries, power converters, inductive charging components, transformers, line-power components, solar power components, and otherwise.

### Server Security 208

The server 104 may be further configured to include a server security 208. The server security 208 may be provided as a hardware security component, a software executed security component, and/or a combination thereof. Security components are well known in the art and may include any known or later arising security hardware and/or software components, including computer instructions, or combinations thereof, that are configured to secure content, communications, restrict access to devices, processes, components, and data therewith, and otherwise. The server security 208 may be used to facilitate secure transmission, processing, storage, and otherwise of any data used in accordance with an implementation of the present disclosure.

### Server User Interface 210

The server 104 may be further configured to include a server user interface 210. The server user interface 210 may include any known or later arising human to device interface components, processes and technologies. User interfaces are well-known in the art and non-limiting examples include interfaces facilitating human to device communication of information in any form including include audible inputs (such as spoken commands) and outputs (generated sound), visible inputs (such as eye tracking and facial recognition) and outputs (such as visible images presented on a display device, LEDs, or otherwise), touch inputs (such as on a trackpad, touch screen or otherwise), touch feedback (such as vibrations or other movements), gesture tracking, and otherwise. The server user interface 210 may be coupled to and/or include the one or more presentation devices (not shown). The presentation devices facilitate interactions between a user thereof and the server 104. Non-limiting examples of presentation devices include speakers, displays, and others.

### Server Communications Interface 212

The server 104 may be further configured to include a server communications interface 212. The server communications interface 212 may be configured to use any known or later arising communications and/or networking technologies which facilitate use of the network 110 (as further described below). Communication interfaces are well-known in the art and non-limiting examples include Ethernet cards, USB and storage medium interface cards, radio frequency transceivers, and others.

### Node 102

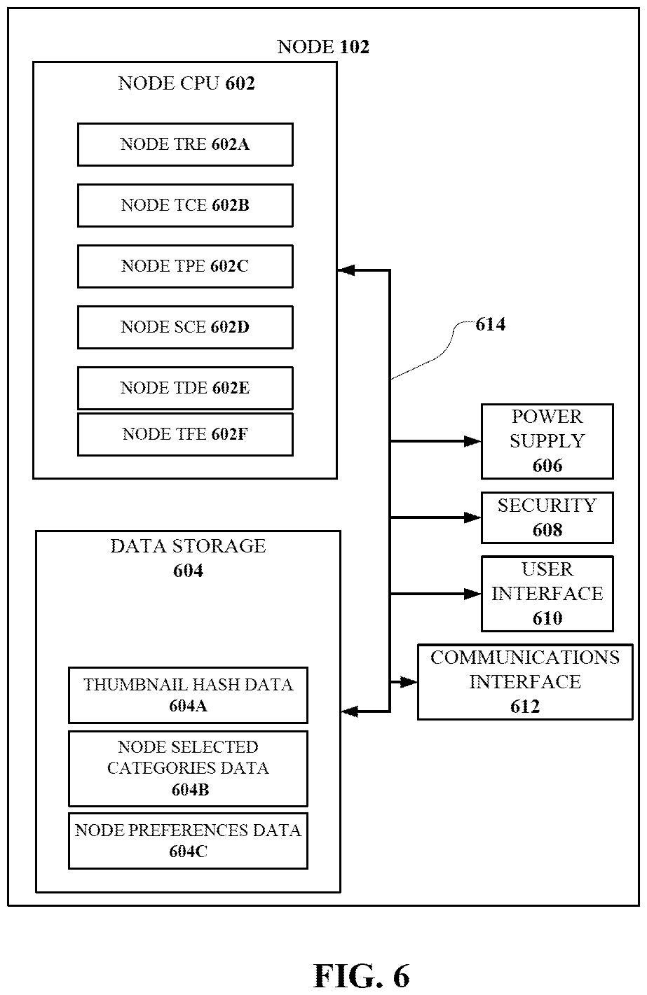

Referring again to FIG. 1 and as shown in FIG. 6, for at least one implementation, the system 100 includes a node 102 coupled to the server 104, optionally coupled to the source 106 and the database 108.

The nodes 102 may be similarly configured to the server 104 to include one or more node CPUs 602, data storage 604, user interface 610, power supplies 606, security 608, and communications interface 612 components. Non-limiting examples of nodes 102 include smartphones, laptop computers, tablet computing devices, desktop computers, smart televisions, smart glasses, virtual reality glasses, augmented reality glasses, earbuds/headphones and other audible output devices, application programs, web servers, and other devices.

### Node CPU 602

More specifically, and as shown in FIG. 6, the nodes 102 may be include a node CPU 602. The node CPU 602 may be provided by any processing device capable of executing one more computer instructions which, in accordance with an implementation of the present disclosure, facilitates one or more data processing operations including, and not limited to, one or more computer engines such as a node thumbnail recognition engine 602A, a node thumbnail categorization engine 602B, a node thumbnail production engine 602C, a node selected category engine 602D and a node thumbnail display engine 602E (such computer engines are further described below). One or more of the computer engines 602-A/E may be combined, included, not included, distributed across one or more devices, such as being provided in whole or in part by a node 102, a network component 110, at the server 104, or otherwise.

The node CPU 602 may include one or more physical (as compared to logical) components configured for such data processing operations. The node CPU 602 may include one or more hardware processors, such as 32-bit and 64-bit central processing units, multi-core ARM based processors, microprocessors, microcontrollers, and otherwise. The processors provided by the node CPU 602 may be localized, distributed, Cloud based, or otherwise provided. The computer instructions may include one or more engines. Such engines may arise in any computing configuration including, and not limited to, local, remote, distributed, blade, virtual, or other configurations and/or systems configured for use in support of an implementation of one or more embodiments of the present disclosure.

### Node Thumbnail Recognition Engine 602A

The node 102 may execute computer instructions instantiating a Node Thumbnail Recognition Engine (“NTRE”) 602A. For at least one implementation, the NTRE 602A facilitates recognition of thumbnails by performing one or more operations, such as those shown in FIG. 3. For an implementation, the TRE 202A and the NTRE 602A may be configured to independently and/or cooperatively recognize thumbnails.

### Node Thumbnail Categorization Engine 602B

The node 102 may execute computer instructions instantiating a Node Thumbnail Categorization Engine (“NTCE”) 602B. For at least one implementation, the NTCE 602B facilitates recognition of thumbnails by performing one or more operations, such as those shown in FIG. 4. For an implementation, the TCE 202B and the NTCE 602B may be configured to independently and/or cooperatively recognize thumbnails.

### Node Thumbnail Production Engine 602C

The node 102 may execute computer instructions instantiating a Node Thumbnail Production Engine (“NTPE”) 602C. For at least one implementation, the NTPE 602C facilitates recognition of thumbnails by performing one or more operations, such as those shown in FIG. 5. For an implementation, the TPE 202C and the NTPE 602C may be configured to independently and/or cooperatively recognize thumbnails.

### Node Selected Category Engine 602D

The node 102 may execute computer instructions instantiating a Node Selected Category Engine (“NSCE”) 602D. For at least one implementation, the NSCE 602D facilitates recognition of thumbnails by performing one or more operations by which a user of a node identifies one or more top-level and /or lower level categories for which thumbnails are not to be presented.

### Node Thumbnail Display Engine 602E

The node 102 may execute computer instructions instantiating a Node Thumbnail Display Engine (“NTDE”) 602E. For at least one implementation, the NTDE 602E facilitates presentation/display thumbnails by performing one or more presentation operations such as outputting a thumbnail in a data format suitable for presentation to a user via a presentation device, non-limiting examples including in a standard definition, High Definition, 4K format, 8K format, or otherwise.

### Node Thumbnail Filter Engine 602F

The node 102 may execute computer instructions instantiating a Node Thumbnail Filter Engine (“NTFE”) 602F. For at least one implementation, the NTFE 602F facilitates filtering for presentation/display/storage or otherwise by a node 102 of thumbnails by performing one or more filtering operations. For at least one implementation, a node 102 may be configured to independently verify whether a given thumbnail, content element, or otherwise includes content that falls is acceptable for presentation based on one or more filter categories. For a non-limiting example, a thumbnail may be acceptable for presentation at certain times of day and not others. For another non-limiting example, a thumbnail may be acceptable for presentation on certain displays, such as a TV, and not others, such as a moving automobile's infotainment system.

For at least one implementation, the node 102 and the various engines executed thereby may be configured to generate node thumbnail hash data 604A, node selected categories data 604B, node preferences data 604C, and other data. The node thumbnail hash data 604A may correspond to thumbnail hash data 204A stored on the server 104, at the database 108, or otherwise. The node selected categories data 604B may similarly so correspond to node selected categories data 204B. The node preferences data 604C may identify one or more preferences for one or more users of a given node. Such user preferences may be utilized in identifying and selecting one or more categories for including in a given node selected categories file maintained on the node 102, the server 104, or otherwise. Multiple node selected categories files may be maintained for one or more nodes.

The various node engines may be configured to cooperate with other engines provided by the node 102, the server 104, or otherwise.

### Node Data Storage 604

The node CPU 602 may be communicatively coupled, by a node data bus 614 or similar structure, to a node data storage 604, which may also be referred to as a “computer readable storage medium.” The node data storage 604 may be a single storage device, multiple storage devices, or otherwise. The node data storage 604 may be provided locally with a given node 102 or remotely, such as a data storage service provided on the Cloud, by the database 108, and/or otherwise. Storage of data including, and not limited to, node thumbnail hash data 604A, node selected categories data 604B, node preferences data 604C, and other data may be managed by a storage controller (not shown) or similar component.

It is to be appreciated that a storage controller manages the storing of data and may be instantiated in one or more of the node data storage 604, the node CPU 602, on the Cloud, on the database 108, on the server 104, or otherwise. Any known or later arising storage technologies may be utilized. Non-limiting examples of devices that may be configured for use as node data storage 604 include electrical storage devices, such as EEPROMs, random access memory (RAM), Flash drives, and solid-state drives, optical drives such as DVDs and CDs, magnetic storage devices, such as hard drive discs, magnetic drives, magnetic tapes, memory cards, such as Compact Flash (CF), Secure Digital (SD) cards, Universal Serial Bus (USB) cards, and others.

Available storage provided by the node data storage 604 may be partitioned or otherwise designated by the storage controller, or otherwise, as providing for permanent storage and temporary storage. Non-transient data, transient data, computer instructions, or the like may be suitably stored in the node data storage 604 for any amount of time used to execute one or more computer instructions. While being used for execution of a computer instruction, such data is herein considered to be non-transient. While stored by the storage device, data is herein considered to be non-transient. As used herein, permanent storage is distinguished from temporary storage, with the latter providing a location for temporarily storing data, variables, or other instructions used for a then arising data processing operations. A non-limiting example of a temporary storage device is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient computer instructions and other data.

The node 102 may be any computing device capable of facilitating one or more of the operations described herein and/or otherwise provided by an implementation of the present disclosure.

### Node Power Supply 606

The node 102 may be configured to include a node power supply 606. The node power supply 606 may include any known or later arising technologies which facilitate the storage, supplying, transforming, or other use of electrical energy. Non-limiting examples of such technologies include batteries, power converters, inductive charging components, transformers, line-power components, solar power components, and otherwise.

### Node Security 608

The node 102 may be further configured to include a node security 608. The node security 608 may be provided as a hardware security component, a software executed security component, and/or a combination thereof. Security components are well known in the art and may include any known or later arising security hardware and/or software components, including computer instructions, or combinations thereof, that are configured to secure content, communications, restrict access to devices, processes, components, and data therewith, and otherwise. The node security 608 may be used to facilitate secure transmission, processing, storage, and otherwise of any data used in accordance with an implementation of the present disclosure.

### Node User Interface 610

The node 102 may be further configured to include a node user interface 610. The node user interface 610 may include any known or later arising human to device interface components, processes and technologies. User interfaces are well-known in the art and non-limiting examples include interfaces facilitating human to device communication of information in any form including include audible inputs (such as spoken commands) and outputs (generated sound), visible inputs (such as eye tracking and facial recognition) and outputs (such as visible images presented on a display device, LEDs, or otherwise), touch inputs (such as on a trackpad, touch screen or otherwise), touch feedback (such as vibrations or other movements), gesture tracking, and otherwise. The node user interface 610 may be coupled to and/or include the one or more presentation devices 103. The presentation device 103 facilitates interactions between a user thereof and the node 102. Non-limiting examples of presentation devices include speakers, displays, and others.

### Node Communications Interface 612

The node 102 may be configured to include node communications interface 612. The node communications interface 612 may be configured to use any known or later arising communications and/or networking technologies which facilitate use of the network 110. Communication interfaces are well-known in the art and non-limiting examples include Ethernet cards, USB and storage medium interface cards, radio frequency transceivers, and others.

### Network 110

As shown in FIG. 1 and for at least one implementation, the system 100 includes a network 110 that communicatively couples one or more of the node 102, the server 104, the source 106 and the database 108.

For at least one implementation, nodes 102 may be directly or indirectly coupled to the source 106 and/or to the database 108. The database 108 may be directly or indirectly coupled to the source 106. The network 110 may utilize any known and/or later arising communications and/or networking technologies, standards, protocols or otherwise. Non-limiting examples of such technologies include packet switch and circuit switched communications technologies, such as and without limitation, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, Internet of Things (IoT) networks, Cloud based networks, private networks, public networks, or otherwise.

The network 110 may utilize mid-band and/or high band 5G communications frequencies. As is commonly known and appreciated, mid-band 5G communications frequencies typically support communications of 100-400 Mb/s download and are typically deployed over 2.4 GHz to 4.2 GHz frequencies. Likewise, high band 5G communications frequencies typically support communications of 1-2 Gb/s download and are typically deployed over 24-72 GHz frequencies.

One or more communications and networking standards and/or protocols may be used including, without limitation, the TCP/IP suite of protocols, the Extensible Message and Presence Protocol (XMPP), VOIP, Ethernet, Wi-Fi, CDMA, GSM/GRPS, TDMA/EDGE, EV/DO, WiMAX, SDR, LTE, 5G, MPEG, and others.

As shown in FIG. 1, one or more communications links may be established between nodes 102, the server 104, the source 106, and the database 108. It is to be appreciated that any combination of communications links may be combined or provided as single, multiple or other combinations of communication links. Accordingly, it is to be appreciated that the communications links are described herein for purposes of functional explanation and are not limited to any particular physical configurations.

### Database 108

As shown in FIG. 1, the system 100 may include a database 108. The database 108 may be provided on the Cloud, one or more servers 104, on one or more nodes 102, sources 106, and/or otherwise. The database 108 provide data storage of data and information relevant to facilitating thumbnail image replacement and other operations. Such data may be replicated, in whole or in part, on the server data storage 204, on the node data storage 604, or otherwise.

Although various implementations have been described above with a certain degree of particularity, or with reference to one or more individual implementations, those skilled in the art could make numerous alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more embodiments of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes and are not intended to be limiting to any orientation or configuration of any elements or sequences of operations for the various embodiments of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings shall be interpreted as illustrative of embodiments and not limiting. Changes in detail or structure may be made without departing from the basic elements of the present disclosure as defined in the following claims.

What is claimed is:

1. A computer-implemented method comprising:
receiving an identification of a source for a thumbnail for a given content;
receiving the thumbnail, at a server, from the source;
computing, at the server, a hash value for the thumbnail;
associating, in a database accessible to the server, the hash value with the thumbnail;
receiving an identification of a user of a given node;
wherein the given node is coupled to the server; and
determining by the server whether to output the thumbnail to the given node for presentation to the given user.

2. The computer-implement method of claim 1,
wherein the source is a provider of augmented reality content.

3. The computer-implemented method of claim 2,
wherein the thumbnail is received, from the source, as a non-Humanly Visually Perceptible (nHPV) formatted thumbnail (an “nHPV thumbnail”); and
the method further comprises:
converting the thumbnail from the nHPV format into a Humanly Visually Perceptible (HPV) thumbnail (an “HPV thumbnail”).

4. The computer-implemented method of claim 3, further comprising:
performing image analysis on the HPV thumbnail; and
based on a result of the image analysis;
identifying a top-level category; and
determining whether the HPV thumbnail corresponds with the top-level category;
when corresponding, applying a category label, associated with the top-level category, to the HPV thumbnail; and
based on the top-level category, determining whether to output the thumbnail to the given node for presentation by the given node to the given user.

5. The computer-implemented method of claim 4,
wherein the top-level category corresponds to an explicit nudity category.

6. The computer-implemented method of claim 4, further comprising:
based on a result of the image analysis;
identifying a second-level category;
further categorizing the HPV thumbnail as corresponding with the second-level category; and
based on the second-level category, second determining whether to output the thumbnail to the given node for presentation by the give node to the given user.

7. The computer-implement method of claim 6, further comprising:
filtering the thumbnail based on at least one of a time of day, a type of device, and location filter for the given node.

8. The computer-implemented method of claim 7,
wherein the hash value facilitates the filtering of the thumbnail.

9. The computer-implemented method of claim 4, further comprising:
at the given node,
receiving the HPV thumbnail with the category label;
determining whether the category label corresponds to a node selected category; and
when corresponding, preventing presentation of the HPV thumbnail.

10. The computer-implemented method of claim 9, further comprising:
when presentation of the HPV thumbnail is prevented,
at the given node,
requesting a replacement thumbnail for presentation in lieu of the HPV thumbnail; and
at the server,
identifying a replacement thumbnail; and
communicating the replacement thumbnail to the given node.

11. The computer-implemented method of claim 10,
wherein the replacement thumbnail is a generic thumbnail associated with at least one of a genre, actor, channel, producer, director and theme for the given content.

12. The computer-implemented method of claim 11,
wherein the nHPV thumbnail comprises a sound; and
wherein the HPV thumbnail comprises a graphical image.

13. The computer-implemented method of claim 12,
wherein the given content comprises one of a television program, a movie, a streaming video, and graphical images associated with a computer game.

14. A non-transitory machine-readable storage medium having stored thereon computer instructions which, when executed by a processor of an electronic device, cause the processor to perform operations comprising:
launching an image analysis application;
selecting a top-level category to apply to a thumbnail;
providing the thumbnail to the image analysis application;
applying the selected top level category to the thumbnail to determine if the thumbnail satisfies the top-level category; and
if satisfied,
associating the top level category with the thumbnail; and
outputting the thumbnail for presentation at a given node when content in the top-level category is acceptable for presentation at the given node.

15. The non-transitory machine-readable storage medium of claim 14, wherein the computer instructions further cause the processor to perform operations further comprising:
repeating at least one of the launching, selecting, providing, applying, associating and outputting operations with respect to a second-level category.

16. The non-transitory machine-readable storage medium of claim 14,
wherein the top-level category categorizes thumbnails as including nudity; and
wherein the second-level category is a subset of the top-level category and further categorizes thumbnails as including explicit nudity.

17. The non-transitory machine-readable storage medium of claim 14, wherein the computer instructions further cause the processor to perform operations further comprising:
filtering the thumbnail for presentation at the given node based upon at least one of a time of day at the given node and a location of the given node.

18. An electronic device comprising:
a data storage;
a processor coupled to the data storage;
wherein the processor executes non-transient computer instructions which cause the processor to perform operations including:
receive an identification of a node to receive a proposed thumbnail;
obtain a node selected category for the node;
receive the proposed thumbnail to provide to the node;
determine if the proposed thumbnail has been previously recognized and categorized;
if not previously recognized and categorized,
perform thumbnail recognition operations and categorization operations to generate a thumbnail categorization for the proposed thumbnail;
determine whether a match occurs between the node selected category and the thumbnail categorizations;
if a match does not occur,
communicate the proposed thumbnail to the node;
if a match does occur,
flag the proposed thumbnail as not suitable for the node;
identifying a replacement thumbnail; and
communicate the replacement thumbnail to the node.

19. The electronic device of claim 18,
wherein the non-transient computer instructions further cause the processor to perform operations including:
obtain a filter setting associated with a node;
determine whether the node, at a given current time, satisfies the filter setting; and
if satisfied not communicate a thumbnail to the node.

20. The electronic device of claim 19,
wherein the filter setting identifies, for the node, at least one of a device type, a time of day, and a location when thumbnails are not to be provided to the node.
